(19) United States
(12) Patent Application Publication
(10) Pub. No.: US 2012/0147066 A1
(43) Pub. Date: Jun. 14, 2012

(54) DRIVER DEVICE, BACKLIGHT UNIT, AND IMAGE DISPLAY APPARATUS

(75) Inventors: Kohji Fujiwara, Osaka-shi (JP); Takayuki Murai, Osaka-shi (JP)

(73) Assignee: SHARP KABUSHIKI KAISHA, Osaka-shi, Osaka (JP)

(21) Appl. No.: 13/390,564

(22) PCT Filed: Mar. 10, 2010
(86) PCT No.: PCT/JP2010/053974

§ 371 Date: Feb. 15, 2012

(30) Foreign Application Priority Data
Aug. 31, 2009 (JP) 2009-199210

(51) Int. Cl. G09G 3/36; G09G 3/32; G09G 5/10

(52) U.S. Cl. 345/690; 345/102

(57) ABSTRACT

Disclosed is a backlight unit (16) for supplying backlight to a liquid crystal panel (15a), the backlight unit being provided with a plurality of LEDs (16b) that function as a light source of the backlight, and an LED driver (5) that comprises a plurality of control channels (1-12 ch) to each of which one or more of the LEDs are connected, and that PWM-controls lighting of the connected LEDs. The LED driver (5) can set the frequency or phase of the PWM control independently for each of the control channels (1-12 ch). Consequently, the flexibility of control of LEDs can be increased while the number of necessary LED drivers is reduced to a minimum.

### TECHNICAL FIELD

The present invention relates to a driver device that controls a light emitting element, and a backlight unit and an image display apparatus that include the driver device.

### BACKGROUND ART

Conventionally, as an apparatus that displays images, a liquid crystal display apparatus utilizing the characteristics of liquid crystal has been widely used. Furthermore, as one example of a backlight unit used in a liquid crystal display apparatus or the like, a backlight unit using a light emitting diode (LED) as a light source for backlight is disclosed, for example, in Patent Document 1.

Such a backlight unit using an LED generally includes an LED driver for controlling the LED. Furthermore, there exists an LED driver of a type including a plurality of channels for establishing connection to LEDs to be controlled (hereinafter, may be referred to as a “multichannel type” for the sake of convenience).

Furthermore, as a method of controlling LEDs, generally used is a PWM (pulse width modulation) method. According to the control based on the PWM method (PWM control), switching between lighting and extinction occurs based on a state of a PWM signal (whether the PWM signal is at an H level or at an L level). According to a multichannel type LED driver that performs PWM control, a condition used for the PWM control (a duty ratio, a frequency, a phase, etc.) is specified beforehand, and LEDs connected to channels of the LED driver, respectively, are turned on in accordance with the specified condition.

As described above, the use of a multichannel type LED driver allows a plurality of LEDs to be turned on collectively by a single LED driver. Thus, even in a backlight unit in which a multitude of LEDs are arranged, by the use of a multichannel type LED driver, the required number of LED drivers is reduced to a minimum, and thus, for example, a simplified configuration of an internal circuit can be achieved easily.

### LIST OF CITATIONS

### Patent Literature

Patent Document 1: JP-A-2005-310996

### SUMMARY OF THE INVENTION

### Technical Problem

As described above, the use of a multichannel type LED driver that performs

PWM control allows a plurality of LEDs to be turned on by a single LED driver. In a conventional multichannel type LED driver that performs PWM control, however, control conditions for the PWM control such as a frequency and a phase are common to channels. This has been problematic in that these control conditions cannot be set independently for each channel, resulting in a poor degree of freedom in controlling LEDs.

In order that these control conditions can be set independently for each channel, required information (a clock signal, etc.) needs to be transmitted individually for each channel. This leads to an increase in the required amount of signal lines and so on, making it likely that a circuit design or the like of an LED driver becomes complicated.

Moreover, as will be described later with regard to examples, understandably, it is useful to set these control conditions independently for each channel, but the usefulness itself conventionally has hardly been appreciated. This is conceivably the reason why a conventional LED driver is not designed so that these items can be set independently for each channel.

Surely, even if control conditions cannot be set independently for each channel, it seems possible to prevent a decrease in the freedom in controlling LEDs by assigning each individual LED driver to each group of LEDs to be controlled independently. This, however, might end in an undesirable result such as an increase in the required number of LED drivers.

In view of the above-described problem, it is an object of the present invention to provide a backlight unit and an image display apparatus that use a light emitting element as a light source for backlight and are capable of improving the freedom in controlling the light emitting element while reducing the required number of driver devices to a minimum, and a driver device that is used favorably in the backlight unit.

### Solution to the Problem

In order to achieve the above-described object, a backlight unit according to the present invention is a backlight unit that supplies backlight to a panel on which an image is displayed and includes: a plurality of light emitting elements each of which functions as a light source for the backlight; and a driver device that has a plurality of control channels to each of which one or more of the light emitting elements are connected, and performs PWM control of lighting of the connected light emitting elements. In the backlight unit, the driver device sets a frequency or phase for the PWM control independently for each of the control channels.

This configuration adopts, as a driver device for controlling a light emitting element that acts as a light source for backlight, a driver device that has a plurality of control channels and sets a frequency or phase for PWM control independently for each control channel. This makes it possible to further improve the freedom in controlling a light emitting element while reducing the required number of driver devices to a minimum.

Furthermore, the above-described configuration may be as follows. That is, the backlight unit receives data on an image to be displayed on the panel, and based on the image data, generates control information specifying a frequency or phase for PWM control for each of the control channels. Based on the control information, the driver device sets the frequency or phase for PWM control.

According to this configuration, a frequency or phase for PWM control for each control channel can be set based on data on an image to be displayed on a panel.

Furthermore, an image display apparatus according to the present invention includes: the backlight unit having the above-described configuration; a panel unit that has the panel and uses the backlight to display on the panel, an image based on image data received; and an image data supply portion that obtains image data and supplies the image data to the backlight unit and to the panel unit.

This configuration makes it possible to display an image on a panel and to control, based on the displayed image, a lighting state of backlight.

Furthermore, the above-described configuration may be as follows. That is, an image display area of the panel is composed of a plurality of parts, and each of the light emitting elements is brought into correspondence with one of the parts. After determining, with respect to each of the parts, whether or not a degree of inter-frame luminance variation of the image data is higher than a prescribed reference, the backlight unit generates the control information so that, with respect to those of the control channels corresponding to those of the light emitting elements corresponding to a part among the parts, which has a value of the degree of inter-frame luminance variation not higher than the prescribed reference, a frequency for the PWM control is set to a prescribed first frequency, and so that, with respect to those of the control channels corresponding to those of the light emitting elements corresponding to a part among the parts, which has a value of the degree of inter-frame luminance variation higher than the prescribed reference, the frequency for the PWM control is set to a second frequency lower than the first frequency.

According to this configuration, processing equivalent to black screen insertion is performed only with respect to a part in which luminance varies relatively largely, thereby making it possible to maximally achieve both the reduction of a moving image blur and the suppression of occurrence of a pseudo-contour.

Furthermore, the above-described configuration may be as follows. That is, every time switching of a frame of the image data occurs, the backlight unit randomly determines a phase for PWM control for each of the control channels from among predetermined candidate phases and generates control information specifying the determined phase for PWM control. This configuration makes it possible to maximally prevent the occurrence of color breaking, which causes discomfort to a viewer.

Furthermore, the above-described configuration may be as follows. That is, based on image data received, the panel unit scans the panel and thereby displays an image on the panel. An image display area of the panel is formed in a plurality of tiers, and each of the light emitting elements is brought into correspondence with one of the tiers. The backlight unit generates the control information so that, with respect to those of the control channels corresponding to those of the light emitting elements corresponding to one tier, a phase for the PWM control is set so that phase coincidence is achieved among them. This configuration makes it possible to maintain moving image displaying performance at a further increased level.

Furthermore, a backlight unit of another configuration according to the present invention is a backlight unit that supplies backlight to a panel on which an image is displayed and includes: a plurality of light emitting elements each of which functions as a light source for the backlight; and a driver device that has a plurality of control channels to each of which one or more of the light emitting elements are connected, and performs PWM control of lighting of the connected light emitting elements. In the backlight unit, the driver device sets a non-lighting time period in which a light emitting element is set not to be turned on, independently for each of the control channels.

This configuration adopts, as a driver device for controlling a light emitting element that acts as a light source for backlight, a driver device that has a plurality of control channels and sets a non-lighting time period independently for each control channel. This makes it possible to easily realize image display based on a field sequential method while reducing the required number of driver devices to a minimum.

Furthermore, an image display apparatus of another configuration according to the present invention includes: the backlight unit having the above-described configuration; a panel unit that has the panel and uses the backlight to display on the panel, an image based on image data received; and an image data supply portion that obtains image data and supplies the image data to the backlight unit and to the panel unit. The image display apparatus realizes display of each frame of the image by displaying fields of a plurality of colors. Each of the light emitting elements emits light of one of the plurality of colors. The backlight unit receives the image data and generates control information specifying a time period designated for each of the fields of a plurality of colors. Based on the control information, the driver device sets, in the time period designated for each of the fields, a non-lighting time period with respect to those of the control channels corresponding to the light emitting elements of the colors other than the color of the each of the fields. This configuration makes it possible to realize image display based on the field sequential method.

Furthermore, a driver device according to the present invention is a driver device that has a plurality of control channels to each of which one or more light emitting elements are connected, and performs PWM control of lighting of the connected light emitting elements. The driver device sets a frequency or phase for the PWM control independently for each of the control channels. This configuration enables the formation of the backlight unit having the above-described configuration.

Furthermore, a driver device of another configuration according to the present invention is a driver device that has a plurality of control channels to each of which one or more light emitting elements are connected, and performs PWM control of lighting of the connected light emitting elements. The driver device sets a non-lighting time period in which a light emitting element is set not to be turned on, independently for each of the control channels. This configuration enables the formation of the above-described backlight unit of another configuration.

Furthermore, in the driver devices and backlight units having the above-described configurations, respectively, each of the light emitting elements may be an LED.

### Advantageous Effects of the Invention

As described in the foregoing, according to the backlight unit of the present invention, as a driver device for controlling a light emitting element that acts as a light source for backlight, a driver device is used that has a plurality of control channels and is configured so that a frequency or a phase for PWM control is set independently for each of the control channels. This makes it possible to improve the freedom in controlling a light emitting element while reducing the required number of driver devices to a minimum.

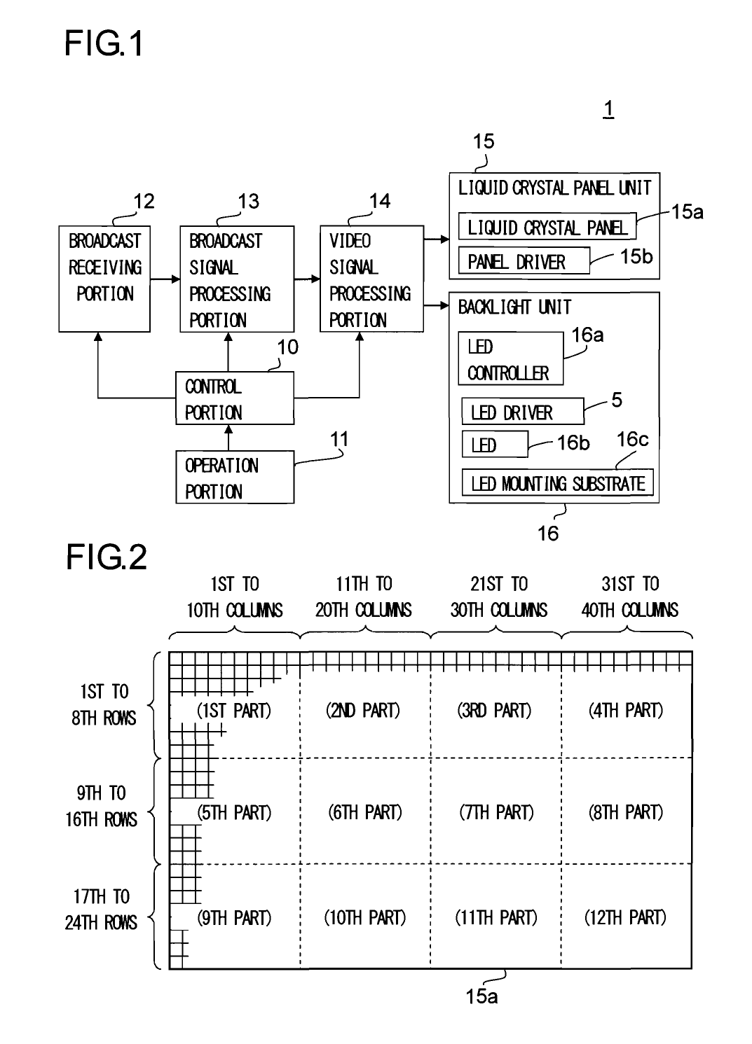

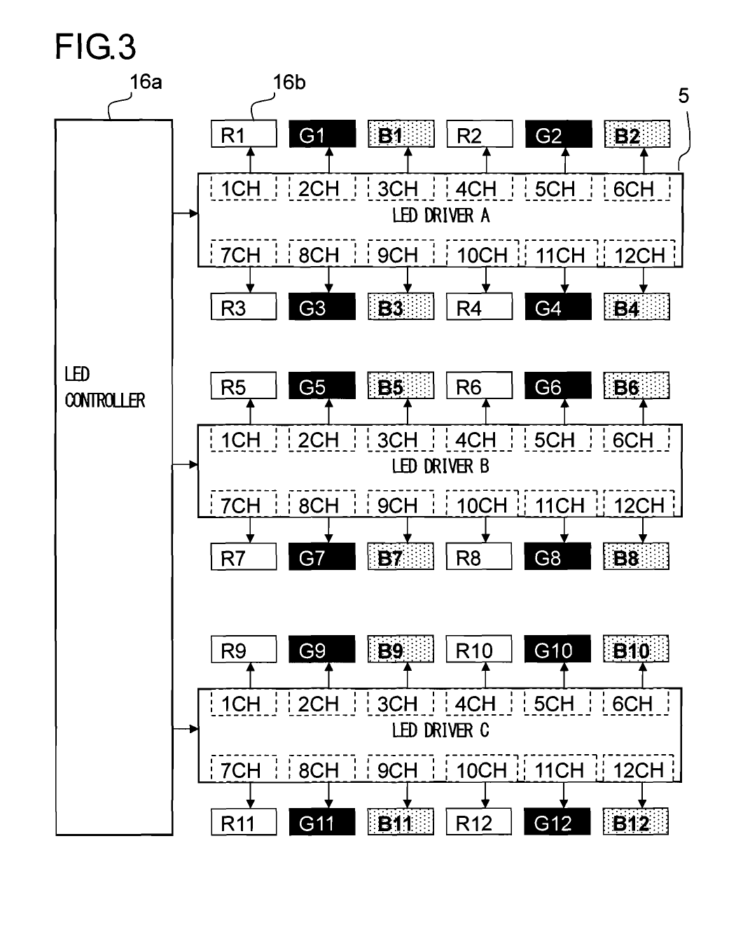

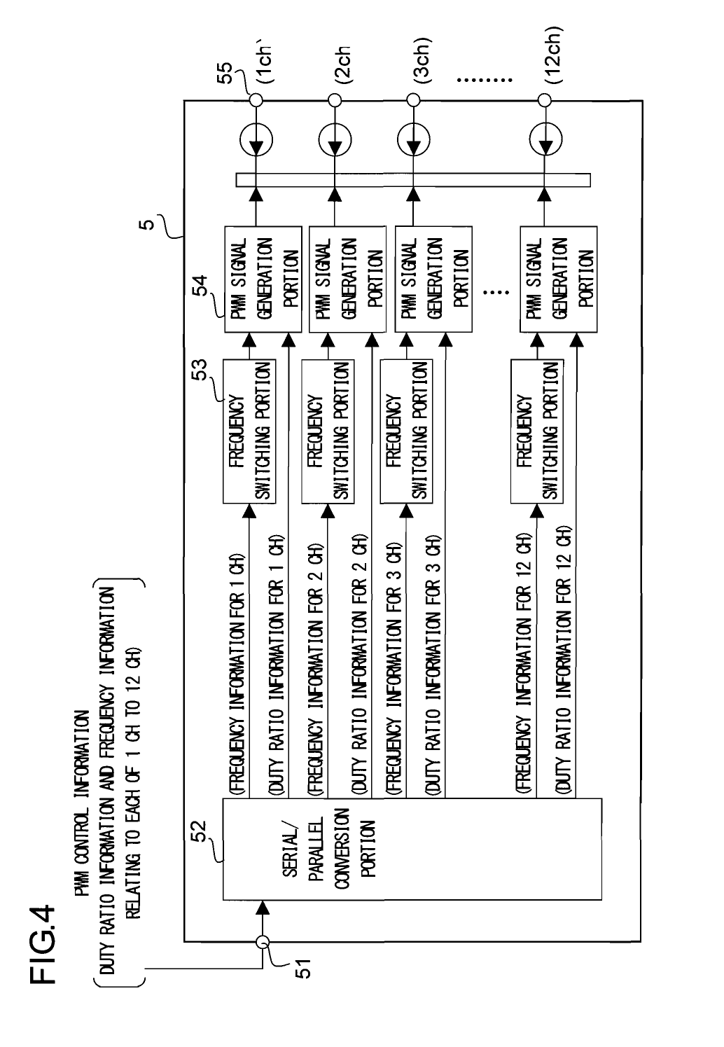

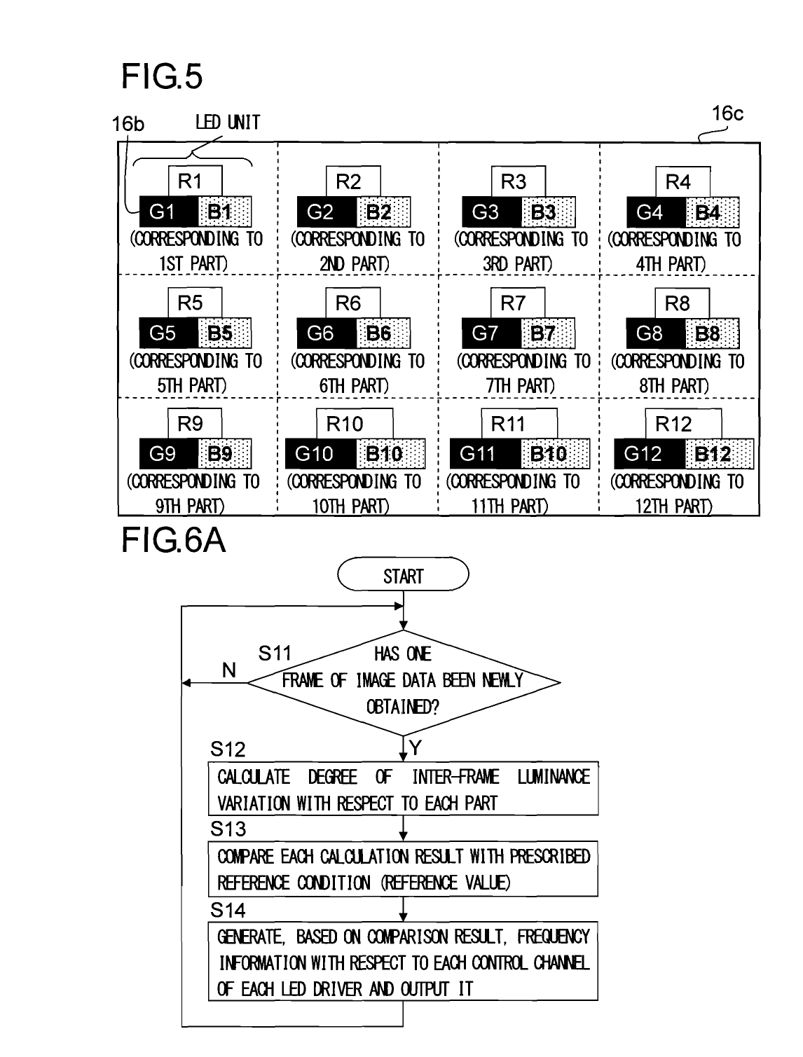

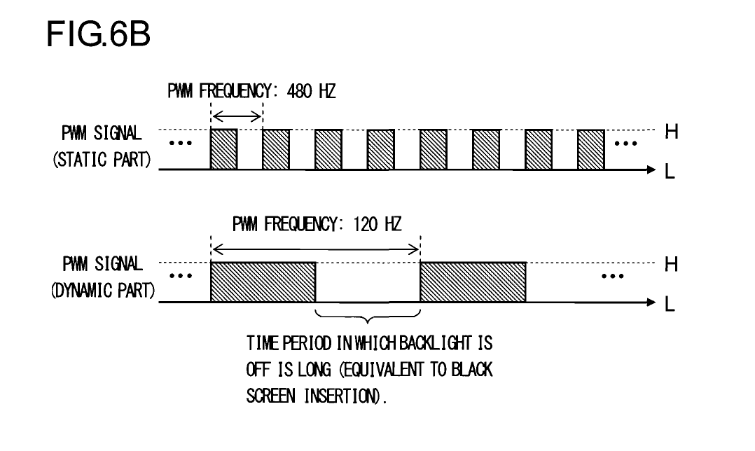

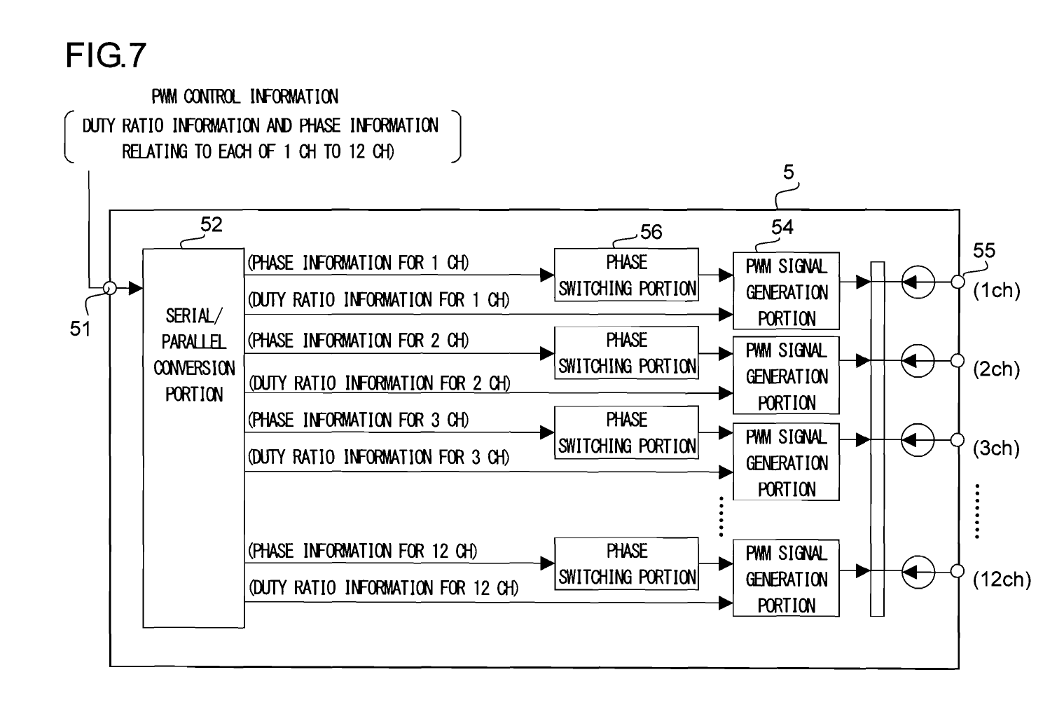

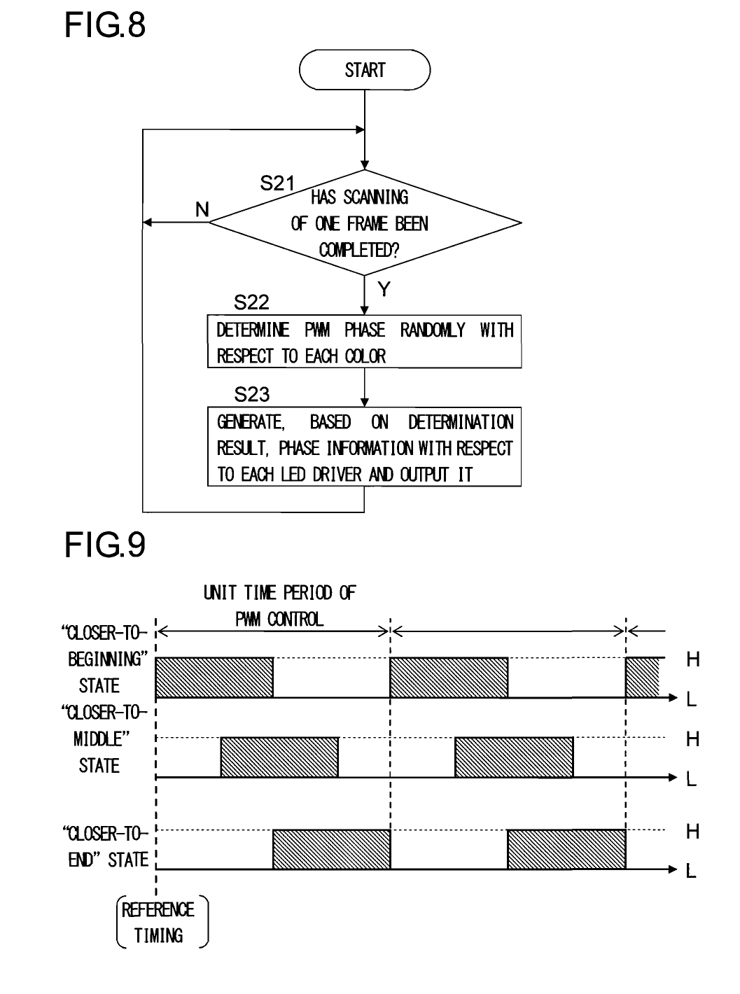

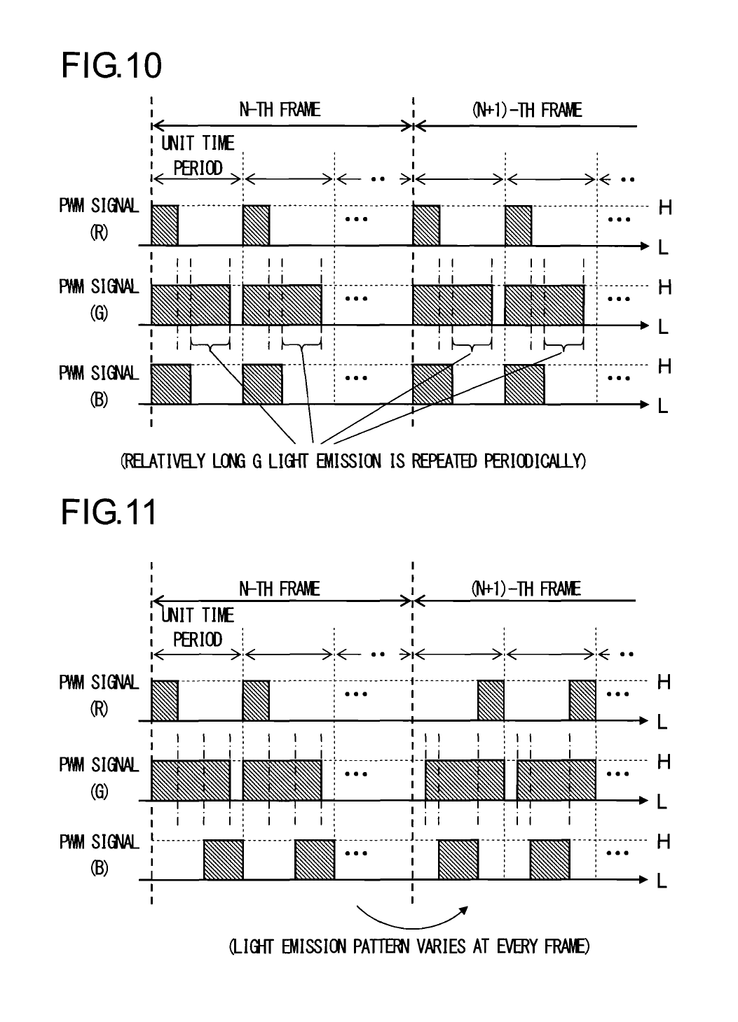

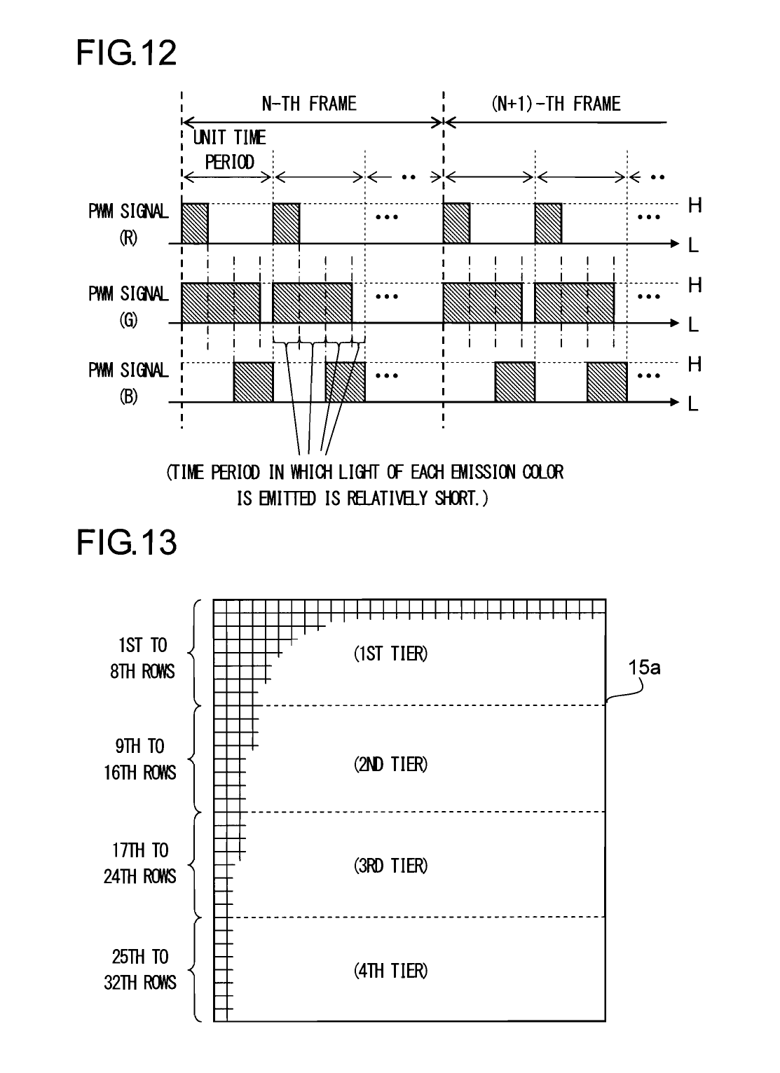

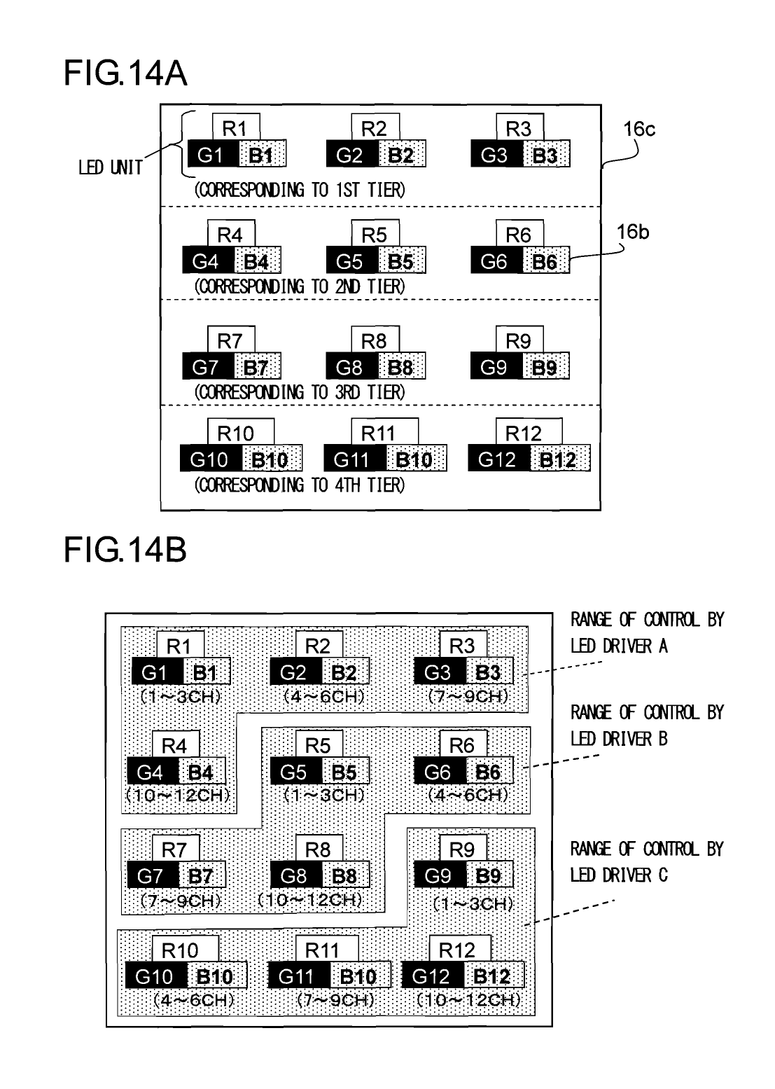

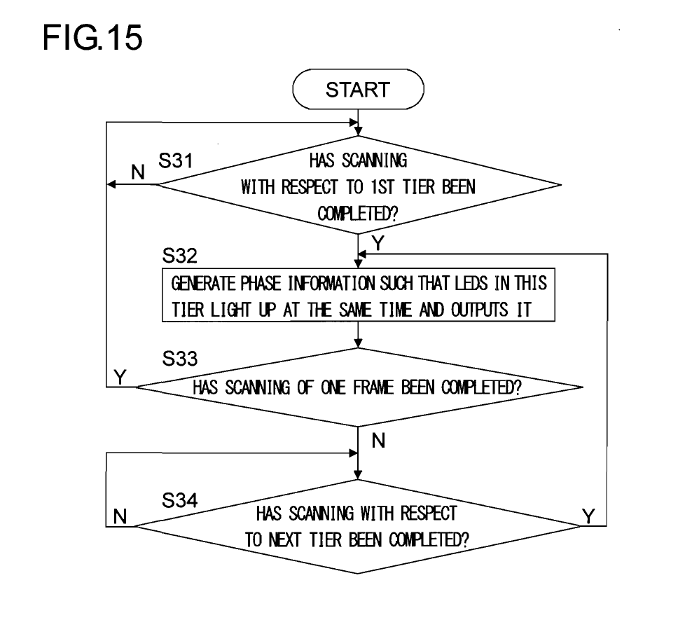

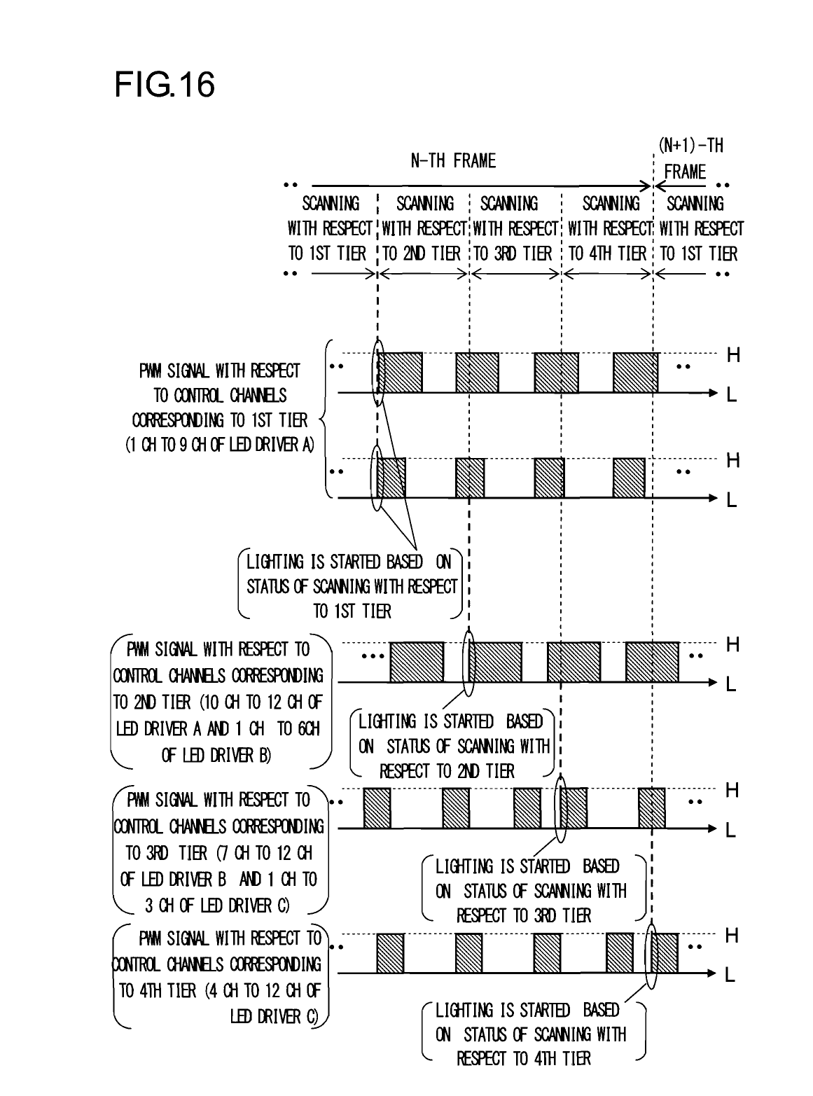

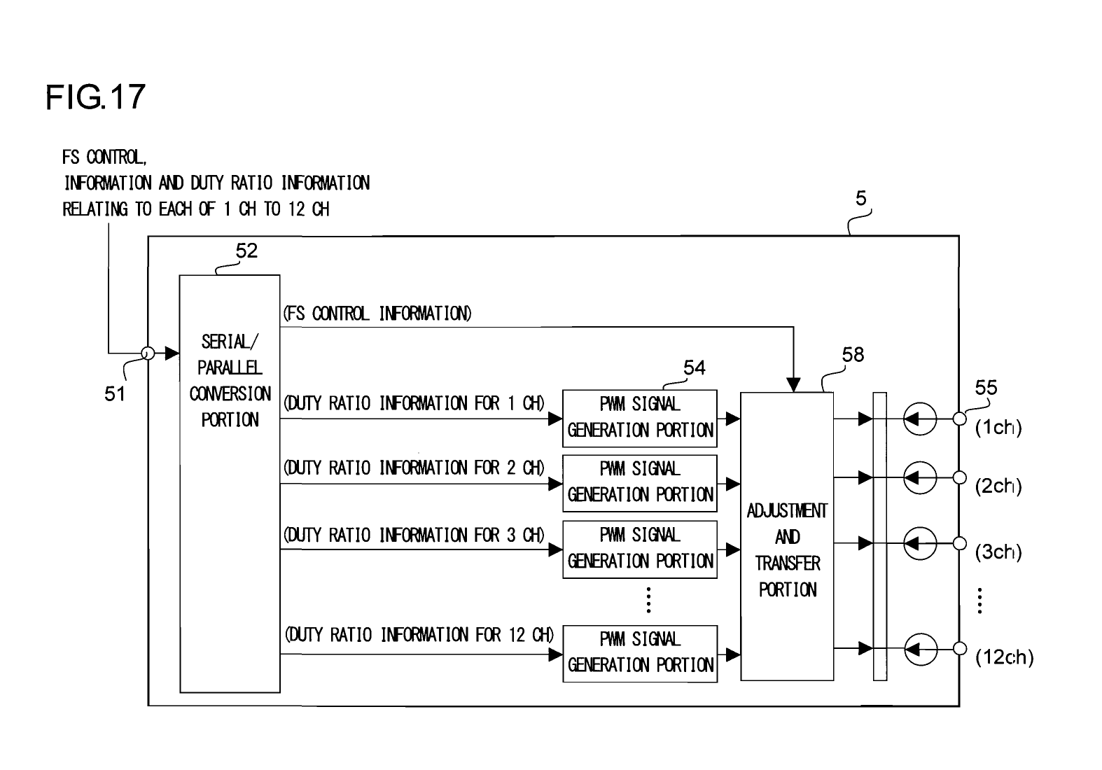

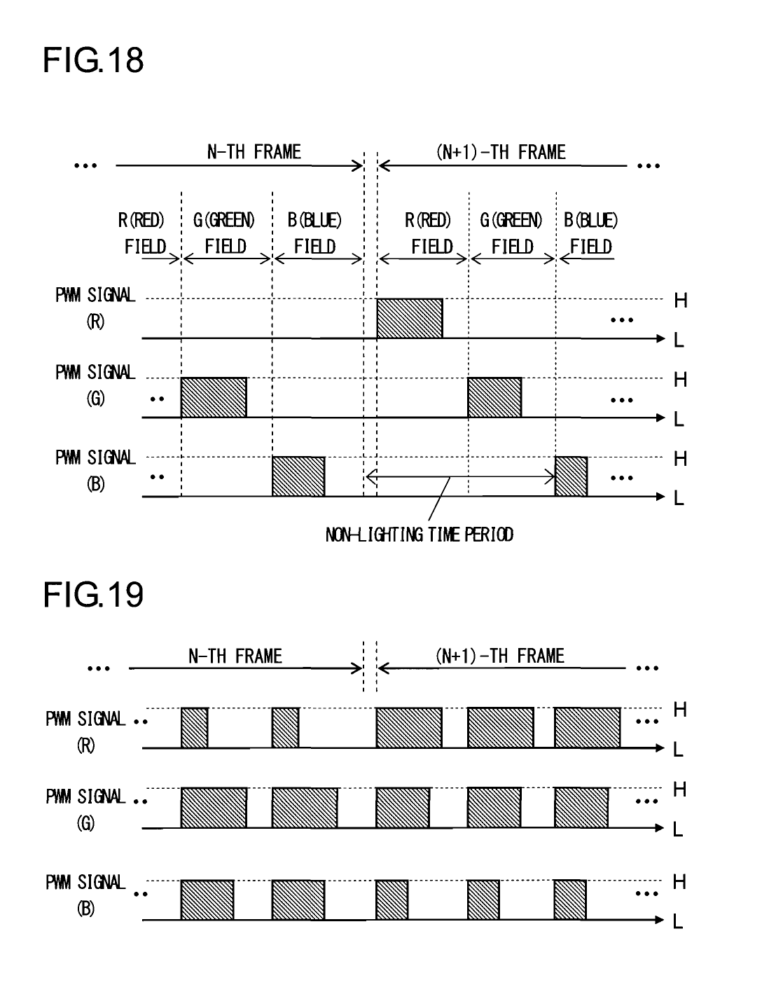

### BRIEF DESCRIPTION OF DRAWINGS

[FIG. 1] is a configuration diagram of a television broadcast receiver according to an embodiment of the present invention.

[FIG. 2] is an explanatory diagram relating to a display area of a liquid crystal panel according to some examples of the present invention including Example 1.

[FIG. 3] is a configuration diagram of a backlight unit according to some examples of the present invention including Example 1.

[FIG. 4] is a configuration diagram of an LED driver according to Example 1 of the present invention.

[FIG. 5] is an explanatory diagram showing an arranged state of LEDs according to some examples of the present invention including Example 1.

[FIG. 6A] is a flow chart relating to operations of an LED controller according to Example 1 of the present invention.

[FIG. 6B] shows timing charts of PWM signals relating to Example 1 of the present invention.

[FIG. 7] is a configuration diagram of an LED driver according to some examples of the present invention including Example 2.

[FIG. 8] is a flow chart relating to operations of an LED controller according to Example 2 of the present invention.

[FIG. 9] is an explanatory diagram relating to a phase for PWM control.

[FIG. 10] shows timing charts of PWM signals relating to a conventional device.

[FIG. 11] shows timing charts of PWM signals relating to Example 2 of the present invention.

[FIG. 12] shows, as another example, timing charts of PWM signals relating to Example 2 of the present invention.

[FIG. 13] is an explanatory diagram relating to a display area of a liquid crystal panel according to Example 3 of the present invention.

[FIG. 14A] is an explanatory diagram showing an arranged state of LEDs according to Example 3 of the present invention.

[FIG. 14B] is another explanatory diagram showing the arranged state of LEDs according to Example 3 of the present invention.

[FIG. 15] is a flow chart relating to operations of an LED controller according to Example 3 of the present invention.

[FIG. 16] shows timing charts of PWM signals relating to Example 3 of the present invention.

[FIG. 17] is a configuration diagram of an LED driver according to Example 4 of the present invention.

[FIG. 18] shows timing charts of PWM signals relating to Example 4 of the present invention.

[FIG. 19] shows, as another example, timing charts of PWM signals relating to Example 4 of the present invention.

### DESCRIPTION OF EMBODIMENT

Hereinafter, an embodiment of the present invention will be described by way of Examples 1 to 4.

### EXAMPLE 1

First, by exemplarily using a television broadcast receiver (one form of an image display apparatus), the following describes Example 1 of the present invention.

FIG. 1 is a schematic configuration diagram of the television broadcast receiver.

As shown in this figure, a television broadcast receiver 1 includes a control portion 10, an operation portion 11, a broadcast receiving portion 12, a broadcast signal processing portion 13, a video signal processing portion 14, a liquid crystal panel unit 15, a backlight unit 16, and so on.

The control portion 10 controls the various portions of the television broadcast receiver 1 and operates them to carry out various types of processing necessary for the television broadcast receiver 1 to fulfill its functions (such as a function of displaying images of television broadcasts). Furthermore, the operation portion 11 is provided with a switch that is operated by a user and transmits user's instructions entered through the switch operation to the control portion 10. By this configuration, user's intentions can be reflected in various types of operations of the television broadcast receiver 1.

The broadcast receiving portion 12 has an antenna, a tuner device, and so on and continuously receives broadcast signals transmitted from television stations. Broadcast channel selection and so on are controlled by the control portion 10. A received broadcast signal is sent out to the broadcast signal processing portion 13.

The broadcast signal processing portion 13 extracts a video signal and an audio signal from a broadcast signal and sends out the video signal to the video signal processing portion 14 and the audio signal to an unshown speaker device (device that generates a sound based on an audio signal).

The video signal processing portion 14 subjects a video signal received from the upstream side to necessary processing (such as, for example, decompression processing or color tone adjustment processing). The video signal that has undergone such processing is sent out to the liquid crystal panel unit 15 and to the backlight unit 16. Similarly to a generally-used video signal format, the video signal is composed of a luminance signal corresponding to each of RGB (red, green, and blue) pixels, a synchronization signal, a clock signal, and so on.

By this configuration, data on an image of each of frames constituting a picture (data specifying an image to be displayed, timing at which the image is to be displayed, etc.) is continuously transmitted to the liquid crystal panel unit 15 and to the backlight unit 16.

The liquid crystal panel unit 15 includes a liquid crystal panel 15a, a panel driver 15b, and so on. The liquid crystal panel 15a has the same configuration as that of a generally-used panel for a liquid crystal display, which has a plurality of pixels (having electrodes disposed so as to be opposed to each other via liquid crystal), RGB color filters corresponding to the pixels, respectively, and so on. With this configuration, in the liquid crystal panel 15a, a voltage of an electrode provided in each of the pixels is adjusted, and the degree of transmittance of backlight supplied to the each of the pixels is thereby adjusted.

Furthermore, as shown in FIG. 2, an image display area of the liquid crystal panel 15a is made up of 24 pixels (in a vertical direction) by 40 pixels (in a horizontal direction). As also shown in FIG. 2, the display area is composed of three parts (in the vertical direction) by four parts (in the horizontal direction), equaling 12 parts (1st to 12th parts). For example, the 1st part includes pixels belonging to the range of the 1st to 8th rows as seen from the top and also to the range of the 1st to 10th columns as seen from the left.

In the present application, the term “part” is defined for the sake of convenience to indicate part of the display area. Furthermore, as will be described in detail later, each of the parts is brought into correspondence with an LED situated on the rear side thereof (namely, an LED that mainly irradiates the each of the parts with backlight).

Based on a video signal (image data) received from the video signal processing portion 14, the panel driver 15b adjusts a voltage of each of the pixel electrodes of the liquid crystal panel 15a. To be more specific, after obtaining new one frame of image data, in accordance with the one frame of image data, the panel driver 15b successively sets voltages of the pixel electrodes row by row (in the present example, in order from the top row) toward a given direction (in the present example, from the left side to the right side) (in the present application, this operation is referred to as “scanning”). By this configuration, when the liquid crystal panel 15a is irradiated from behind with backlight, an image is displayed in the display area of the liquid crystal panel 15a.

Furthermore, the backlight unit 16 includes an LED controller 16a, an LED driver 5 (LED drivers A to C), an LED 16b (R1 to R12, G1 to G12, and B1 to B12), an LED mounting substrate 16c, and so on. Furthermore, the various portions in the backlight unit 16 are connected in a manner shown in FIG. 3.

Based on a video signal (image data) received from the video signal processing portion 14, the LED controller 16a generates PWM control information and sends it out to the LED driver 5. Herein, PWM control information refers to information prescribing a condition used for PWM control. The present example uses, as PWM control information, duty ratio information (information specifying a duty ratio for PWM control) and frequency information (information specifying a frequency for PWM control), which correspond to each control channel (as will be described later, 1 ch to 12 ch are provided) of each of the LED drivers 5.

With respect to each control channel of each of the LED drivers 5, a proper duty ratio (determined based on, for example, an emission color of an LED connected thereto) is specified beforehand, and the specified duty ratio is registered in the LED controller 16a. This registered information is used as duty ratio information to be sent out to the LED driver 5. For example, if duty ratio information has yet to be sent out to the LED driver 5 or if there is renewed duty ratio information, such duty ratio information is sent out to the LED driver 5.

On the other hand, frequency information to be sent out to the LED driver 5 is determined based on image data received every time image data is received. A description as to how the LED controller 16a determines frequency information will be made later.

The LED driver 5 has the 12 control channels (1 ch to 12 ch) to each of which one or a plurality of LEDs are connected. In accordance with PWM control information received from the LED controller 16a, the LED driver 5 controls lighting of the LEDs 16b connected to the control channels, respectively, by the PWM method (method in which an LED is set to be on in a time period in which a PWM signal is at an H level and to be off in a time period in which the PWM signal is at an L level). Herein, the following describes a configuration of the LED driver 5.

FIG. 4 is a configuration diagram of the LED driver 5. As shown in this figure, the LED driver 5 includes an information input terminal 51, a serial/parallel conversion portion 52, a frequency switching portion 53, a PWM signal generation portion 54, an LED connection terminal 55, and so on. As for the portions on the downstream side of the serial/parallel conversion portion 52 (frequency switching portion 53, PWM signal generation portion 54, and LED connection terminal 55), 12 systems of them are provided so as to correspond to the control channels 1 ch to 12 ch, respectively.

The information input terminal 51 is a terminal that receives an input of PWM control information from the upstream side of the LED driver 5 (herein, the LED controller 16a).

The serial/parallel conversion portion 52 distributes PWM control information inputted to the information input terminal 51 to the frequency switching portion 53 or the PWM signal generation portion 54 in each of the systems, depending on contents of the PWM control information. To be more specific, the serial/parallel conversion portion 52 sends out a piece of frequency information corresponding to N (N represents a numeral from 1 to 12) ch to the frequency switching portion 53 of N ch and a piece of duty ratio information corresponding to N ch to the PWM signal generation portion 54 of N ch.

The frequency switching portion 53 generates a signal (frequency switching signal) for switching a frequency for PWM control based on a piece of frequency information received and sends it out to the PWM signal generation portion 54 in a corresponding one of the systems.

In accordance with a newest (most recently received) piece of duty ratio information and a frequency switching signal, the PWM signal generation portion 54 generates a PWM signal (signal in which an H level and an L level alternate at a predetermined duty ratio) and outputs it to the downstream side in a corresponding one of the systems.

As described above, according to the LED driver 5, a frequency for PWM control can be set independently for each control channel. Thus, it is also possible to set a different frequency for PWM control for each control channel. A phase of each PWM signal (timing at which it attains an H level or an L level) may be set beforehand to be in a certain state or may be controlled using an externally inputted signal or the like.

In a time period in which a PWM signal is at an H level, a prescribed amount of an electric current is fed to an LED connected to the LED connection terminal 55 of a corresponding one of the control channels, and thus the LED lights up (emits light). On the other hand, in a time period in which the PWM signal is at an L level, such an electric current is not fed, and thus the LED connected to the LED connection terminal 55 of the corresponding one of the control channels goes out.

It is also possible to connect, instead of only one LED, a plurality of LEDs to each of the LED connection terminals 55 within the rated range of the LED driver 5. Furthermore, the number of the control channels, formats of the various types of signals, and so on are not limited to those described above and may be variously changed. Furthermore, one LED driver 5 is assumed to be constituted by one IC chip but may also take other forms.

Referring back to FIG. 1, the LED 16b is constituted by, for example, an LED chip and disposed on a mounting surface of the LED mounting substrate 16c to function as a light source for backlight for the liquid crystal panel 15a. Furthermore, the LED mounting substrate 16c is mounted to the rear side of the liquid crystal panel 15a, with the mounting surface thereof facing the liquid crystal panel 15a.

As shown in FIG. 3, 12 red light emitting LEDs 16b (indicated by “R” in the figure), 12 green light emitting LEDs 16b (indicated by “G” in the figure), and 12 blue light emitting LEDs 16b (indicated by “B” in the figure), i.e. a total of 36 LEDs 16b are provided. Furthermore, as also shown in FIG. 3, each of the LEDs 16b is connected to one of the control channels of one of the LED drivers 5. For example, the red light emitting LED 16b indicated by “R1” is connected to 1 CH of the LED driver A.

Furthermore, as shown in FIG. 5, the LEDs 16b are arranged on the LED mounting substrate 16c in such a manner that each set of LEDs 16b that emit light of the respective colors of R (red), G (green), and B (blue) constitutes an LED unit. Each of the LED units emits light of the respective colors of RGB and thus, as a whole, emits substantially white light.

The LED units are arranged at a substantially equal spacing from each other so as to correspond to the parts described earlier (1st to 12th parts), respectively (that is, so that, when seen from an image display direction, one LED unit coincides with one part). By this configuration, when a light emitting state of any LED unit varies, such a variation mainly affects an image display state in one of the parts corresponding thereto.

Next, the following describes operations of the LED controller 16a with reference to a flow chart shown in FIG. 6A. In the LED controller 16a, information indicating which LED 16b is connected (corresponds) to each of the control channels of each of the LED drivers 5 and information indicating to which part each of the LEDs 16b corresponds are registered beforehand.

As described earlier, image data is continuously sent out from the video signal processing portion 14 to the LED controller 16a. Under such a situation, the LED controller 16a monitors whether or not one frame of image data has been newly obtained (Step S11).

If one frame of image data has been obtained (Y in Step S11), the LED controller 16a calculates, with respect to a partial image displayed in each of the parts, a degree of inter-frame variation in luminance (information contained in a luminance signal) (Step S12). To be more specific, with respect to each pixel belonging to one part, a difference in luminance between a newly obtained frame and a frame that has been immediately previously obtained is determined, and an average value of the differences is calculated. The average value is thus determined as a degree of inter-frame luminance variation of the one part. This calculation is carried out with respect to all the parts. This calculation procedure, however, is illustrative only, and other procedures may be adopted instead.

Subsequently, the LED controller 16a compares each value as a result of this calculation with a preset reference condition (herein, a reference value) (Step S13). For the sake of convenience, a part with a value as the calculation result not higher than the reference value is referred to as a “static part”, and a part with a value as the calculation result higher than the reference value is referred to as a “dynamic part”. After that, based on results of this comparison, the LED controller 16a further determines a piece of frequency information with respect to each of the control channels of each of the LED drivers 5.

To be more specific, pieces of frequency information with respect to those, among the control channels of each of the LED drivers 5, to which a set of LEDs 16b corresponding to each static part are connected, respectively, are determined to be a first frequency (for example, 480 Hz), which is a normal frequency. On the other hand, pieces of frequency information with respect to those, among the control channels of each of the LED drivers 5, to which a set of LEDs 16b corresponding to each dynamic part are connected, respectively, are determined to be a second frequency (for example, 120 Hz), which is lower than the normal frequency.

The LED controller 16a then generates pieces of frequency information as determined and outputs them to a corresponding one of the LED drivers 5 (Step S14). As a result of the operation at Step S14, each of the LED drivers 5 performs PWM control of lighting of the LEDs 16b connected thereto in accordance with frequency information newly received at and after this point in time. After the operation at Step S14 has been carried out, the flow of the operations of the LED controller 16a returns to the operation at Step S11. FIG. 6B shows one example of timing charts of PWM signals in the present example. In this figure, the chart corresponding to the static part is shown on the upper side, and the chart corresponding to the dynamic part is shown on the lower side.

As is evident from FIG. 6B, as a consequence of the above-described sequence of operations, switching between lighting and extinction of a backlight (a set of LEDs 16b corresponding to each dynamic part) installed on the rear side of each dynamic part is performed relatively gradually. As a result, in each dynamic part, a time period in which the backlight installed on the rear side thereof remains off (in other words, a time period in which a black screen is being displayed) becomes relatively long, and thus it follows that processing equivalent to black screen insertion has been performed.

The “black screen insertion” refers to a technique of intentionally providing, during the time of displaying moving images, a time slot in which a display panel is prevented from emitting light (time slot in which a black screen is displayed) and is known as a technique for reducing a so-called moving image blur, which might occur in a liquid crystal display. It is known, however, that black screen insertion with respect to a liquid crystal display having a relatively low response speed (speed at which liquid crystal is controlled to be in a desired state) is likely to cause a problem of a pseudo-contour (multi-contour) on a display screen. Hence, it is rather preferable not to carry out black screen insertion when there is relatively little need for it.

In this regard, in the television broadcast receiver 1, since the above-described sequence of operations are performed, with respect to a display portion in which luminance varies relatively largely, so that a moving image blur is likely to occur (namely, the dynamic part), the processing equivalent to black screen insertion is performed, while with respect to a display portion other than that (namely, the static part), the processing equivalent to black screen insertion is not performed. Thus, according to the television broadcast receiver 1, it is possible to maximally achieve both the reduction of a moving image blur and the suppression of occurrence of a pseudo-contour.

Herein, a case is assumed where, in the backlight unit 16, instead of the LED driver 5, an LED driver of a type that does not allow a frequency for PWM control to be set independently for each control channel (that is, does not allow a frequency for PWM control to be set individually for each control channel) is adopted. In this case, however, other conditions such as the number of control channels are assumed to be the same as in the case of the LED driver 5.

In this case, as shown in FIGS. 3 and 5, a group of LEDs 16b corresponding to the 1st part to the 4th part are controlled by a common LED driver (LED driver A), and thus an equal frequency for PWM control is used for this group of LEDs 16b (in other words, this group of LEDs 16b cannot be made to vary in frequency for PWM control). Furthermore, similarly, an equal frequency for PWM control is used for a group of LEDs 16b corresponding to the fifth part to the eighth part, and an equal frequency for PWM control is used for a group of LEDs 16b corresponding to the 9th part to the 12th part. As a result, an operation in which a frequency for PWM control is set individually for each part is considerably limited.

Surely, it seems that, even if a frequency for PWM control cannot be set independently for each control channel, by assigning an individual LED driver to each part, the above-described operation is enabled. It can be said, however, that such a configuration is disadvantageous in that the required number of LED drivers is increased.

Furthermore, the above configuration is disadvantageous also in that wasteful redundancy of control channels is likely to result. For example, in the above-described exemplary case, even though there are only three LEDs in each part, an LED driver including as many as 12 control channels is used, so that at least nine (12-3) control channels become redundant. With these in view, it can be said that, compared with an LED driver that does not allow a frequency for PWM control to be set independently for each control channel, the LED driver 5 of the present example is advantageous in that the freedom in controlling the LEDs can be increased.

### EXAMPLE 2

Next, again by exemplarily using a television broadcast receiver, the following describes Example 2 of the present invention. Except for a configuration of a backlight unit 16, the present example has essentially the same configuration as that of the television broadcast receiver according to Example 1. In the following, duplicate descriptions, therefore, may be omitted.

Similarly to the case of Example 1, the backlight unit 16 according to Example 2 as a whole has a configuration including an LED controller 16a, an LED driver 5 (LED drivers A to C), an LED 16b (R1 to R12, G1 to G12, and B1 to B12), an LED mounting substrate 16c, and so on. Furthermore, a manner in which the various portions of the backlight unit 16 are connected, an arranged state of the LEDs 16b on the LED mounting substrate 16c, and so on are similar to those in the case of Example 1 (that is, as shown in FIGS. 3 and 5).

Based on a video signal (image data) received from a video signal processing portion 14, the LED controller 16a generates PWM control information and sends it out to the LED driver 5. The present example uses, as PWM control information, duty ratio information (information specifying a duty ratio for PWM control) and phase information (information specifying a phase for PWM control), which correspond to each control channel (1 ch to 12 ch) of each of the LED drivers 5.

With respect to each control channel of each of the LED drivers 5, a proper duty ratio (determined based on, for example, an emission color of an LED connected thereto) is specified beforehand, and the specified duty ratio is registered in the LED controller 16a. This registered information is used as duty ratio information to be sent out to the LED driver 5. For example, if duty ratio information has yet to be sent out to the LED driver 5 or if there is renewed duty ratio information, such duty ratio information is sent out to the LED driver 5.

On the other hand, phase information to be sent out to the LED driver 5 is set to be appropriate by the LED controller 16a so that color breaking in backlight can be suppressed to a maximum extent. A specific description as to how phase information is set will be made later.

The LED driver 5 has the 12 control channels (1 ch to 12 ch) to each of which one or a plurality of LEDs are connected. In accordance with PWM control information received from the LED controller 16a, the LED driver 5 controls lighting of the LEDs 16b connected to the control channels, respectively, by the PWM method (method in which an LED is set to be on in a time period in which a PWM signal is at an H level and to be off in a time period in which the PWM signal is at an L level). Herein, the following describes a configuration of the LED driver 5.

FIG. 7 is a configuration diagram of the LED driver 5. As shown in this figure, the LED driver 5 includes an information input terminal 51, a serial/parallel conversion portion 52, a phase switching portion 56, a PWM signal generation portion 54, an LED connection terminal 55, and so on. As for the portions on the downstream side of the serial/parallel conversion portion 52 (phase switching portion 56, PWM signal generation portion 54, and LED connection terminal 55), 12 systems of them are provided so as to correspond to the control channels 1 ch to 12 ch, respectively.

The information input terminal 51 is a terminal that receives an input of PWM control information from the upstream side of the LED driver 5 (herein, the LED controller 16a).

The serial/parallel conversion portion 52 distributes components of PWM control information inputted to the information input terminal 51 to the phase switching portion 56 or the PWM signal generation portion 54 in each of the systems. To be more specific, the serial/parallel conversion portion 52 sends out a piece of phase information corresponding to N (N represents a numeral from 1 to 12) ch to the phase switching portion 56 of N ch and a piece of duty ratio information corresponding to N ch to the PWM signal generation portion 54 of N ch.

The phase switching portion 56 generates a signal (phase switching signal) for switching a phase for PWM control based on a piece of phase information received and sends it out to a corresponding one of the PWM signal generation portions 54.

In accordance with a newest (most recently received) piece of duty ratio information and a phase switching signal, the PWM signal generation portion 54 generates a PWM signal and outputs it to the downstream side in a corresponding one of the systems. As described above, according to the LED driver 5, a phase for PWM control can be set independently for each control channel. Thus, it is also possible to set a different phase for PWM control for each control channel. A frequency of each PWM signal may be set beforehand to a prescribed value or may be controlled using an externally inputted signal or the like.

In a time period in which a PWM signal is at an H level, a prescribed amount of an electric current is fed to an LED connected to the LED connection terminal 55 of a corresponding one of the control channels, and thus the LED lights up (emits light). On the other hand, in a time period in which the PWM signal is at an L level, such an electric current is not fed, and thus the LED connected to the LED connection terminal 55 of the corresponding one of the control channels goes out.

It is also possible to connect, instead of only one LED, a plurality of LEDs to each of the LED connection terminals 55 within the rated range of the LED driver 5. Furthermore, the number of the control channels, formats of the various types of signals, and so on are not limited to those described above and may be variously changed. Furthermore, one LED driver 5 is assumed to be constituted by one IC chip but may also take other forms.

Next, the following describes operations of the LED controller 16a with reference to a flow chart shown in FIG. 8. In the LED controller 16a, information indicating which LED 16b is connected (corresponds) to each of the control channels of each of the LED drivers 5 and information indicating to which part each of the LEDs 16b corresponds are registered beforehand.

A signal representing timing of scanning (mainly, a synchronization signal) is continuously sent out from the video signal processing portion 14 to the LED controller 16a. Under such a situation, the LED controller 16a monitors whether or not scanning of one frame has been completed (namely, timing at which scanning of one frame is completed) (Step S21).

Upon completion of the scanning of one frame (Y in Step S21), with respect to each of colors (RGB) of the LEDs 16b, the LED controller 16a randomly determines a phase for PWM control from among predetermined candidate phases (Step S22). To be more specific, with respect to each of the colors RGB, a PWM phase is randomly determined to be any one of closer-to-beginning, closer-to-middle, and closer-to-end phases. For example, in a case where a PWM phase for R (red) is determined to be “closer-to-beginning”, a PWM phase with respect to those, among the control channels of each of the LED drivers 5, which are connected to R (red) LEDs 16b, respectively, is determined to be “closer-to-beginning”.

As shown in FIG. 9, the term “closer-to-beginning” refers to a state where a time period in which a PWM signal attains an H level occurs at a time closer to the beginning of a unit time period of PWM control (time period defining a PWM cycle, which is counted from reference timing). Furthermore, the term “closer-to-middle” refers to a state where the time period in which a PWM signal attains an H level occurs at a time closer to the middle (is at substantially the middle) of the unit time period. Furthermore, the term “closer-to-end” refers to a state where the time period in which a PWM signal attains an H level occurs at a time closer to the end of the unit time period.

After having made the determination at Step S22, the LED controller 16a generates pieces of phase information with respect to the LED drivers 5, in which results of the determination are reflected, and outputs each of them to a corresponding one of the LED drivers 5 (Step S23). As a result, each of the LED drivers 5 performs PWM control of lighting of the LEDs 16b connected thereto in accordance with pieces of phase information newly received at and after this point in time. After the operation at Step S23 has been carried out, the flow of the operations of the LED controller 16a returns to the operation at Step S21. In this manner, every time frame switching occurs, a phase for PWM control for each control channel is randomly set from among the predetermined candidate phases (closer-to-beginning, closer-to-middle, and closer-to-end).

As a consequence of the above-described sequence of operations, the degree of occurrence of color breaking in backlight is reduced. Herein, the following describes the reason why the degree of occurrence of color breaking is reduced.

FIG. 10 shows one example of timing charts of PWM signals in a case where an equal phase for PWM control is assumed to be used with respect to all the control channels. In this figure, from the upper side, there are shown a PWM signal corresponding to the R (red) LED 16b, a PWM signal corresponding to the G (green) LED 16b, and a PWM signal corresponding to the B (blue) LED 16b, respectively. The PWM signals corresponding to the RGB LEDs 16b, respectively, vary in duty ratio for PWM control but are equal in phase for PWM control.

As is evident from FIG. 10, in this case, in the unit time period of PWM control, a time period in which G (green) light is emitted is relatively long. Moreover, this G (green) light emission is repeated periodically at every PWM cycle. As a result, a pronounced degree of green color breaking occurs in a displayed image, which might cause discomfort to a viewer.

On the other hand, FIG. 11 similarly shows one example of timing charts of PWM signals in the present example (respective duty ratios with respect to the RGB LEDs 16b are the same as those in the case shown in FIG. 10). As is evident from this figure, in the present example, a light emission pattern of backlight (which color becomes apparent at which timing) varies every time frame switching occurs. As a result, repeated and periodical emission of light of a particular color is avoided, so that color breaking is suppressed to a maximum extent.

In addition to the above-described technique, the following technique can also be adopted to reduce color breaking. That is, respective phases for PWM control with respect to the RGB LEDs 16b are set to be appropriate (so that color breaking is reduced), and the phases thus set are fixed. FIG. 12 shows one example of timing charts of PWM signals in a case where this technique is adopted (respective duty ratios with respect to the RGB LEDs 16b are the same as those in the case shown in FIG. 10).

In this case, respective phases for PWM control with respect to the R (red)

LED 16b and the G (green) LED 16b are set to be closer-to-beginning, and a phase for PWM control with respect to the B (blue) LED 16b is set to be closer-to-end. As a result, a time period in which light of each of the respective emission colors is continued to be emitted is shorter than the time period in which light of the (G) green emission color is continued to be emitted, which is shown in FIG. 10. That is, a time period in which light of a particular color is continued to be emitted for a long time is eliminated. Thus, compared with the case shown in FIG. 10, the occurrence of color breaking is suppressed.

Furthermore, although in the present example, a phase of PWM control is randomly set with respect to each of the emission colors (RGB) of the LEDs 16b, instead, a phase for PWM control may be randomly set with respect to each of the control channels (that is, regardless of the colors). This provides a more irregular light emission pattern of backlight and thus can suppress color breaking. Furthermore, without any particular limitation to the above-described location, a functional portion (device) that randomly determines a phase may be provided at a location in the LED driver 5.

Where it is assumed that, in the backlight unit 16, instead of the LED driver 5, an LED driver of a type that does not allow a phase for PWM control to be set independently for each control channel (that is, does not allow a phase for PWM control to be set individually for each control channel) is adopted, since such adoption limits control of the LEDs, it can be said that it is relatively hard to achieve the above-described operation of suppressing color breaking. With this in view, it can be said that, compared with an LED driver that does not allow a phase for PWM control to be set independently for each control channel, the LED driver 5 of the present example is advantageous in that the freedom in controlling LEDs can be increased.

### EXAMPLE 3

Next, again by exemplarily using a television broadcast receiver, the following describes Example 3 of the present invention. Except for configurations of a liquid crystal panel unit 15 and a backlight unit 16, the present example has essentially the same configuration as that of Example 1, and a configuration of an LED driver 5 is essentially the same as that of Example 2. In describing the present example, duplicate descriptions, therefore, may be omitted.

The liquid crystal panel unit 15 of the present example includes a liquid crystal panel 15a, a panel driver 15b, and so on. Similarly to the case of Example 1, the liquid crystal panel 15a has the same configuration as that of a generally-used panel for a liquid crystal display. Furthermore, the panel driver 15b also has a configuration similar to that in the case of Example 1 and, based on a video signal (image data) received from a video signal processing portion 14, carries out scanning so that an image is displayed in a display area of the liquid crystal panel 15a.

The image display area of the liquid crystal panel 15a of the present example, however, is, as shown in FIG. 13, made up of 32 pixels (in a vertical direction) by 30 pixels (in a horizontal direction). As also shown in FIG. 13, the display area is formed in four tiers (1st to 4th tiers). In the present application, the term “tier” is defined for the sake of convenience to indicate each area obtained by dividing the display area into a plurality of areas in a sub-scanning direction (in the present example, in the vertical direction).

In the present example, the “1st tier” includes pixels belonging to the range of the 1st to 8th rows from the top, the “2nd tier” includes pixels belonging to the range of the 9th to 16th rows from the top, the “3rd tier” includes pixels belonging to the range of the 16th to 24th rows from the top, and the “4th tier” includes pixels belonging to the range of the 25th to 32nd rows from the top. Scanning of each frame is, therefore, started from the rows included in the “1st tier”, then performed with respect to the rows included in the “2nd tier” and the “3rd tier” in this order, and ends upon completion of the scanning with respect to the rows included in the “4th tier”.

Furthermore, as will be described in detail later, each of the tiers is brought into correspondence with an LED situated on the rear side thereof (namely, an LED that mainly irradiates each part therein with backlight). Furthermore, each tier may include a plurality of rows or only one row.

Furthermore, similarly to Example 1, the backlight unit 16 includes an LED controller 16a, an LED driver 5 (LED drivers A to C), an LED 16b (R1 to R12, G1 to G12, and B1 to B12), an LED mounting substrate 16c, and so on. Furthermore, the various portions of the backlight unit 16 are connected in a manner similar to that in Example 1 (that is, as shown in FIG. 3).

Based on an image signal received from the video signal processing portion 14, the LED controller 16a generates a PWM control signal and sends it out to the LED driver 5. The present example uses, as PWM control information, duty ratio information and phase information with respect to each control channel of the LED driver 5.

With respect to each control channel of each of the LED drivers 5, a proper duty ratio (determined based on, for example, an emission color of an LED connected thereto) is specified beforehand, and the specified duty ratio is registered in the LED controller 16a. This registered information is used as duty ratio information to be sent out to the LED driver 5. For example, if duty ratio information has yet to be sent out to the LED driver 5 or if there is renewed duty ratio information, such duty ratio information is sent out to the LED driver 5.

On the other hand, phase information to be sent out to the LED driver 5 is set to be appropriate by the LED controller 16a so that a high level of moving image displaying performance is achieved. A specific description as to how phase information is set will be made later.

The LED 16b is constituted by, for example, an LED chip and disposed on a mounting surface of the LED mounting substrate 16c to function as a light source for backlight for the liquid crystal panel 15a. Furthermore, the LED mounting substrate 16c is mounted to the rear side of the liquid crystal panel 15a, with the mounting surface thereof facing the liquid crystal panel 15a.

As shown in FIG. 3, 12 red light emitting LEDs 16b (indicated by “R” in the figure), 12 green light emitting LEDs 16b (indicated by “G” in the figure), and 12 blue light emitting LEDs 16b (indicated by “B” in the figure), i.e. a total of 36 LEDs 16b are provided. Furthermore, as also shown in FIG. 3, each of the LEDs 16b is connected to one of the control channels of one of the LED drivers 5. For example, the red light emitting LED 16b indicated by “R1” is connected to 1 CH of the LED driver A.

Furthermore, as shown in FIG. 14A, the LEDs 16b are arranged on the LED mounting substrate 16c in such a manner that each set of LEDs 16b that emit light of the respective colors of R (red), G (green), and B (blue) constitutes an LED unit. Each of the LED units emits light of the respective colors of RGB and thus, as a whole, emits substantially white light. The LED drivers 5 have their respective control ranges (defining which LEDs 16b they are to control) shown in FIG. 14B. That is, the control range of the LED driver A covers all the LEDs 16b corresponding to the 1st tier and some of the LEDs 16b corresponding to the 2nd tier, the control range of the LED driver B covers the rest of the LEDs 16b corresponding to the 2nd tier and some of the LEDs 16b corresponding to the 3rd tier, and the control range of the LED driver C covers the rest of the LEDs 16b corresponding to the 3rd tier and all the LEDs 16b corresponding to the 4th tier.

The LED units are arranged at a substantially equal spacing from each other so that each of them corresponds to one of the above-described tiers (1st to 4th tiers) (that is, so that, when seen from an image display direction, each of the LED units coincides with one of the tiers). By this configuration, when a light emitting state of any LED unit varies, such a variation mainly affects an image display state in one of the tiers corresponding thereto.

Next, the following describes operations of the LED controller 16a with reference to a flow chart shown in FIG. 15. In the LED controller 16a, information indicating which LED 16b is connected (corresponds) to each of the control channels of each of the LED drivers 5 and information indicating to which tier each of the LEDs 16b corresponds are registered beforehand.

A signal representing timing of scanning (mainly, a synchronization signal) is continuously sent out from the video signal processing portion 14 to the LED controller 16a. Under such a situation, the LED controller 16a first monitors timing at which scanning with respect to all the rows belonging to the 1st tier is completed (eventually, equivalent to timing at which scanning with respect to the last row, i.e. the 8th row is completed) (Step S31).

Then, upon completion of the scanning (Y in Step S31), the LED controller 16a generates a piece of phase information such that lighting of the LEDs 16b belonging to the tier with respect to which the scanning has been performed (herein, the 1st tier) is started at the same time (such that phase coincidence is achieved) in accordance with the status of the scanning (for example, at timing when a prescribed time period has elapsed since a point in time of completion of the scanning) and outputs the piece of phase information to one(s) of the LED drivers 5 in need thereof (Step S32). That is, such a piece of phase information with respect to 1 ch to 9 ch of the LED driver A (the control channels corresponding to the LEDs 16b belonging to the 1st tier, respectively) is generated and outputted to the LED driver A.

Subsequently, a similar operation is carried out also with respect to the 2nd, 3rd, and 4th tiers (Steps S34 and S32). Then, upon completion of scanning of one frame (herein, upon completion of scanning with respect to the 4th tier) (Y in Step S33), the operation at Step S31 is repeated for a subsequent frame.

Herein, FIG. 16 shows one example of timing charts of PWM signals in a case where the above-described sequence of operations are performed. In FIG. 16, the first chart from the top shows a PWM signal with respect to one control channel corresponding to the 1st tier, and the second chart from the top shows a PWM signal with respect to another control channel corresponding to the 1st tier.

As shown by these charts, phases of these PWM signals are set so that lighting of all the LEDs 16b corresponding to the 1st tier is started at the same time in accordance with the status of scanning with respect to the first tier.

Furthermore, in FIG. 16, the third chart from the top shows a PWM signal with respect to one control channel corresponding to the 2nd tier, the fourth chart from the top shows a PWM signal with respect to one control channel corresponding to the 3rd tier, and the last chart at the bottom shows a PWM signal with respect to one control channel corresponding to the 4th tier.

As shown by these charts, phases of these PWM signals are set so that lighting of the LEDs 16b corresponding to the 2nd tier is started at the same time, so that lighting of the LEDs 16b corresponding to the 3rd tier is started at the same time, and so that lighting of the LEDs 16b corresponding to the 4th tier is started at the same time, in accordance with the respective statuses of scanning with respect to these tiers.

As described above, in the present example, with respect to the control channels corresponding to the LEDs 16b corresponding to one tier, a phase for PWM control are set so that phase coincidence is achieved among them, and thus timing of lighting in each of the tiers can be set to be equal. Thus, according to the present example, compared with a case where timing of lighting in each tier cannot be set to be equal (a case where timing of lighting in one tier may vary), deterioration in apparent scanning resolution is prevented, and thus the effects provided by processing equivalent to black screen insertion can be obtained more effectively, so that moving image displaying performance can be maintained at the highest possible level.

Where it is assumed that, in the backlight unit 16, instead of the LED driver 5, an LED driver of a type that does not allow a phase for PWM control to be set independently for each control channel (that is, does not allow a phase for PWM control to be set individually for each control channel) is adopted, since such adoption limits control of the LEDs, it can be said that it is relatively hard to achieve the above-described operation of maintaining a high level of moving image displaying performance. With this in view, it can be said that, compared with an LED driver that does not allow a phase for PWM control to be set independently for each control channel, the LED driver 5 of the present example is advantageous in that the freedom in controlling LEDs can be increased.

### EXAMPLE 4

Next, again by exemplarily using a television broadcast receiver, the following describes Example 4 of the present invention. Except for configurations of a liquid crystal panel unit 15 and a backlight unit 16, the present example has essentially the same configuration as that of Example 1, and duplicate descriptions, therefore, may be omitted.

The television broadcast receiver described here displays images by a field sequential method (hereinafter, referred to as an “FS method”) in which fields of respective colors of RGB are displayed. The FS method is already widely known as a method in which one frame is divided into sections (fields) of respective different colors, and the fields of the respective colors are switched from one to another at a high speed (displayed in such a manner as to be shifted in a time axis direction) for image display.

Similarly to the case of Example 1, the liquid crystal panel unit 15 includes a liquid crystal panel 15a, a panel driver 15b, and so on. The liquid crystal panel 15a has the same configuration as that of a generally-used panel for a liquid crystal display adaptable to the field sequential method, which has a plurality of pixels (having electrodes disposed so as to be opposed to each other via liquid crystal), and so on (without color filters corresponding to the pixels, respectively). With this configuration, in the liquid crystal panel 15a, a voltage of an electrode provided in each of the pixels is adjusted, and the degree of transmittance of backlight supplied to the each of the pixels is thereby adjusted.

Based on a video signal (image data) received from a video signal processing portion 14, the panel driver 15b adjusts a voltage of each of the pixel electrodes of the liquid crystal panel 15a. To be more specific, after obtaining one frame of image data, based on the one frame of image data, the panel diver 15b sequentially switches a voltage state of each of the pixel electrodes among a state corresponding to the R (red) field, a state corresponding to the G (green) field, and a state corresponding to the B (blue) field in this order, within a time period in which one frame is displayed.

If a backlight lights up in R (red) when in the state corresponding to the R (red) field, in G (green) when in the state corresponding to the G (green) field, and in B (blue) when in the state corresponding to the B (blue) field, a viewer perceives the respective fields to be integral with one another, thus viewing one frame of an image.

Furthermore, similarly to Example 1, the backlight unit 16 includes an LED controller 16a, an LED driver 5 (LED drivers A to C), an LED 16b (R1 to R12, G1 to G12, and B1 to B12), an LED mounting substrate 16c, and so on. Furthermore, the various portions of the backlight unit 16 are connected in a manner similar to that in Example 1 (that is, as shown in FIG. 3).

Based on image data received from the video signal processing portion 14, the LED controller 16a generates PWM control information and FS control information (information relating to specific conditions used in the FS method) and sends them out to the LED driver 5. The present example uses, as PWM control information, duty ratio information with respect to each control channel of the LED driver 5.

With respect to each control channel of each of the LED drivers 5, a proper duty ratio (determined based on, for example, an emission color of an LED connected thereto) is specified beforehand, and the specified duty ratio is registered in the LED controller 16a. This registered information is used as duty ratio information to be sent out to the LED driver 5. For example, if duty ratio information has yet to be sent out to the LED driver 5 or if there is renewed duty ratio information, such duty ratio information is sent out to the LED driver 5.

Furthermore, FS control information includes field order information (information as to in what order the RGB fields are made to appear, which is registered beforehand), information indicating timing at which each frame starts, information specifying a time period designated for each of the fields (determined based on a synchronization signal, a clock signal, and so on received from the video signal processing portion 14), and so on. According to FS control information, it is possible to distinguish among timings at which the fields of the respective colors should be displayed.

Next, the following describes a configuration of the LED driver 5 with reference to FIG. 17. As shown in this figure, the LED driver 5 includes an information input terminal 51, a serial/parallel conversion portion 52, a PWM signal generation portion 54, an LED connection terminal 55, an adjustment and transfer portion 58, and so on. As for the PWM signal generation portion 54, the LED connection terminal 55, and so on, 12 systems of them are provided so as to correspond to control channels 1 ch to 12 ch, respectively.

The information input terminal 51 is a terminal that receives inputs of PWM control information (duty ratio information) and FS control information from the upstream side of the LED driver 5 (herein, the LED controller 16a).

The serial/parallel conversion portion 52 distributes duty ratio information and FS control information inputted to the information input terminal 51 to the PWM signal generation portion 54 in each of the systems and the adjustment and transfer portion 58, respectively. To be more specific, the serial/parallel conversion portion 52 sends out a piece of duty ratio information with respect to N (N represents a numeral from 1 to 12) ch to the PWM signal generation portion 54 of N ch and FS control information to the adjustment and transfer portion 58.

In accordance with a newest (most recently received) piece of duty ratio information, the PWM signal generation portion 54 generates a PWM signal in which an H level and an L level alternate and outputs it to the adjustment and transfer portion 58. A frequency and a phase used in the control based on a PWM signal may be fixed beforehand to a certain value or to be in a certain sate or may be controlled using an external signal or the like.

Based on FS control information received from the upstream side, the adjustment and transfer portion 58 adjusts a PWM signal to be supplied to the LED connection terminal 55 so that display based on the FS method is realized. To be more specific, based on FS control information, the adjustment and transfer portion 58 constantly monitors a current field state (the field of which color is to be displayed). Furthermore, in the adjustment and transfer portion 58, information indicating the LED 16b of which color is connected (corresponds) to each of the control channels of each of the LED drivers 5 is registered beforehand.

With regard to those of PWM signals transmitted from the PWM signal generation portions 54, which correspond to the color of the current field (that is, correspond to the control channels to which LEDs of that color are connected), the adjustment and transfer portion 58 transfers those PWM signals as they are to the LED connection terminals 55 in the time period in which the current field is to be displayed.

On the other hand, with regard to PWM signals corresponding to the other colors, the adjustment and transfer portion 58 forcibly sets those signals to be at an L level (that is, sets signals to be supplied to the LED connection terminals 55 to be at an L level) in the above-described time period in which the current field is to be displayed. In other words, with regard to the control channels corresponding to those PWM signals, the adjustment and transfer portion 58 sets those channels to be in a non-lighting time period in which an LED is set not to be turned on.

Herein, FIG. 18 shows one example of timing charts relating to PWM signals supplied from the adjustment and transfer portion 58 to the LED connection terminals 55. In this figure, in order from the top, there are shown the chart of a PWM signal corresponding to the control channels to which the R (red) LEDs 16b are connected, respectively, the chart of a PWM signal corresponding to the control channels to which the G (green) LEDs 16b are connected, respectively, and the chart of a PWM signal corresponding to the control channels to which the B (blue) LEDs 16b are connected, respectively.

As shown in FIG. 18, in each of fields of the respective colors of each frame, PWM signals corresponding to the control channels to which the LEDs 16b of the colors other than the color corresponding to the each of fields are set to be at an L level. In a time period in which a PWM signal is at an H level, a prescribed amount of an electric current is fed to LEDs connected to the LED connection terminals 55 of the control channels corresponding to the PWM signal, and thus those LEDs light up (emit light).

On the other hand, in a time period in which a PWM signal is at an L level, such an electric current is not fed, and thus LEDs connected to the LED connection terminals 55 of the control channels corresponding to the PWM signal go out. As a result, in each of the fields of the respective colors, the backlight unit 16 emits light of the color corresponding to the each of the fields, thus realizing image display based on the FS method.

It is possible to connect one or a plurality of LEDs to each of the LED connection terminals 55 within the rated range of the LED driver 5. Furthermore, the number of the control channels, formats of various types of signals, and so on are not limited to those described above and may be variously changed. Furthermore, one LED driver 5 is assumed to be constituted by one IC chip but may also take other forms.

Each of the LEDs 16b is disposed on the LED mounting substrate 16c and functions as a light source for backlight. Furthermore, the LED mounting substrate 16c is installed on the rear side of the liquid crystal panel 15a, with a mounting surface thereof facing the liquid crystal panel 15a.

The LEDs 16b that emit light of the respective colors of R (red), G (green) and B (blue) are arranged in a substantially uniform manner on the LED mounting substrate 16c. By this configuration, a backlight as a whole can efficiently realize a state of being lit in R (red), a state of being lit in G (green), and a state of being lit in B (blue).

As described above, the LED driver 5 according to the present example is favorably used as a device that controls an LED for backlight used in an image display apparatus based on the FS method (FS method-based device). It is more preferable, however, that the LED driver 5 is pre-designed to be usable also as a type that controls an LED for backlight used in an image display apparatus adopting a normal display method (normal method-based device).

As one example, the LED driver 5 is designed so that an operational mode thereof is set to be switchable to either an “FS mode” in which operations suitable as an FS method-based device are performed or a “normal mode” in which operations suitable as a normal method-based device are performed. This allows the LED driver 5 to be used favorably also as a normal method-based device. Switching between these operational modes could be carried out appropriately based on, for example, an externally obtained signal (mode switching signal), and such a mode switching signal may be inputted from the information input terminal 51.

In this case, operations performed in the LED driver 5 could be as follows. That is, when the operational mode is set to the “FS mode”, the operations described above are performed, while when the operational mode is set to the “normal mode”, a PWM signal generated in each of the PWM signal generation portions 54 is supplied to the LED connection terminal 55 without being subjected to any particular processing in the adjustment and transfer portion 58 (without a non-lighting time period being set).

FIG. 19 shows one example of timing charts relating to PWM signals supplied from the adjustment and transfer portion 58 to the LED connection terminals 55 in a case where this operation is performed. In FIG. 19, in order from the top, there are shown the chart of a PWM signal corresponding to the control channels to which the R (red) LEDs 16b are connected, respectively, the chart of a PWM signal corresponding to the control channels to which the G (green) LEDs 16b are connected, respectively, and the chart of a PWM signal corresponding to the control channels to which the B (blue) LEDs 16b are connected, respectively.

As shown in this figure, lighting of the LEDs is controlled by normal PWM control, so that the backlight unit 16 as a whole emits substantially white light. As a result, the LED driver 5 can be used as a normal method-based device.

### Summary

As discussed in the foregoing, the television broadcast receivers 1 according to Examples 1 to 4 include the backlight units 16 that supply backlight to a panel on which images are displayed. Furthermore, the backlight units 16 each include the LED driver 5 for controlling lighting of the LED 16b that functions as a light source. The LED driver 5 according to any one of these examples has a plurality of control channels to each of which one or a plurality of LEDs are connected, and performs PWM control of lighting of the LEDs thus connected.

In the LED driver 5 according to Example 1, a frequency for PWM control is set independently for each control channel. Furthermore, in each of the LED drivers 5 according to Examples 2 and 3, a phase for PWM control is set independently for each control channel. Furthermore, in the LED driver 5 according to Example 4, a non-lighting time period in which an LED is set not to be turned on is set independently for each control channel.

As described above, in each of the LED drivers 5 according to these examples, a prescribed control condition is set independently for each control channel. The LED drivers 5 according to these examples thus have the advantages described in the foregoing with regard to the examples.

Although the examples use an LED as a light source for backlight, instead of an LED, any other type of light emitting element (for example, an organic EL device, a semiconductor laser, etc.) may be used. In such a case, in the backlight unit 16, instead of the LED driver 5, a driver device (having essentially the same configuration as that of the LED driver 5) for lighting the any other type of light emitting element could be used. Furthermore, although LEDs of respective colors of RGB are adopted as light sources for backlight, the descriptions made with regard to Examples 1 and 3 apply also to a case where a W-LED (an LED that emits white light by itself) is adopted instead.

Furthermore, from the viewpoint of the freedom in controlling LEDs, it is preferable that, in the LED driver, a frequency, a phase, or the like for PWM control can be set completely independently for each control channel. This is, however, not necessarily required. For example, the following configuration may be adopted. That is, among control channels 1 ch to 12 ch, with respect to 1 ch to 3 ch, an equal frequency, an equal phase, or the like is used, and similarly, with respect to each of 4 ch to 6 ch, 7 ch to 9 ch, and 10 ch to 12 ch, an equal frequency, an equal phase, or the like is used. This configuration can also provide effects almost equivalent to the effects of the LED drivers according to the examples.

Furthermore, the backlight unit 16 according to any one of Examples 1 to 3 receives data on an image to be displayed on the liquid crystal panel 15a (panel) and generates, based on this image data, PWM control information (control information) specifying a frequency or a phase for PWM control for each of the control channels of the LED driver 5. Based on this PWM control information, the LED driver 5 provided in the backlight unit 16 sets a frequency or a phase for PWM control. Thus, according to the backlight unit 16, it is possible to supply backlight to the liquid crystal panel 15a while taking advantage of the characteristic of the LED driver 5 that a high degree of freedom in control is provided.

The embodiment of the present invention discussed thus far is not intended to limit the present invention thereto. Furthermore, the technical features described in the examples can be used in any combination as long as no contradiction arises. Furthermore, the embodiment of the present invention can be variously modified without departing from the spirit of the present invention.

### INDUSTRIAL APPLICABILITY

The present invention can be applied to an image display apparatus or the like that uses backlight to display images.

### LIST OF REFERENCE SYMBOLS

1 television broadcast receiver (image display apparatus)

5 LED driver (driver device)

10 control portion

11 operation portion

12 broadcast receiving portion

13 broadcast signal processing portion

14 video signal processing portion

15 liquid crystal panel unit

15a liquid crystal panel (panel)

15b panel driver

16 backlight unit

16a LED controller

16b LED (light emitting element)

16c LED mounting substrate

51 information input terminal

52 serial/parallel conversion portion

53 frequency switching portion

54 PWM signal generation portion

55 LED connection terminal

56 phase switching portion

58 adjustment and transfer portion

1. A backlight unit that supplies backlight to a panel on which an image is displayed, comprising:
a plurality of light emitting elements each of which functions as a light source for the backlight; and
a driver device that has a plurality of control channels to each of which one or more of the light emitting elements are connected, and performs PWM control of lighting of the connected light emitting elements,
wherein the driver device sets a frequency or phase for the PWM control independently for each of the control channels.

2. The backlight unit according to claim 1, wherein
the backlight unit receives data on an image to be displayed on the panel, and based on the image data, generates control information specifying a frequency or phase for PWM control for each of the control channels, and
based on the control information, the driver device sets the frequency or phase for PWM control.

3. An image display apparatus, comprising:
the backlight unit according to claim 2;
a panel unit that has the panel and uses the backlight to display on the panel, an image based on image data received; and
an image data supply portion that obtains image data and supplies the image data to the backlight unit and to the panel unit.

4. The image display apparatus according to claim 3, wherein
an image display area of the panel is composed of a plurality of parts,
each of the light emitting elements is brought into correspondence with one of the parts, and
the backlight unit,
after determining, with respect to each of the parts, whether or not a degree of inter-frame luminance variation of the image data is higher than a prescribed reference,
generates the control information so that, with respect to those of the control channels corresponding to those of the light emitting elements corresponding to a part among the parts, which has a value of the degree of inter-frame luminance variation not higher than the prescribed reference, a frequency for the PWM control is set to a prescribed first frequency, and
so that, with respect to those of the control channels corresponding to those of the light emitting elements corresponding to a part among the parts, which has a value of the degree of inter-frame luminance variation higher than the prescribed reference, the frequency for the PWM control is set to a second frequency lower than the first frequency.

5. The image display apparatus according to claim 3, wherein
every time switching of a frame of the image data occurs, the backlight unit randomly determines a phase for PWM control for each of the control channels from among predetermined candidate phases and generates control information specifying the determined phase for PWM control.

6. The image display apparatus according to claim 3, wherein
based on image data received, the panel unit scans the panel and thereby displays an image on the panel,
an image display area of the panel is formed in a plurality of tiers,
each of the light emitting elements is brought into correspondence with one of the tiers, and
the backlight unit generates the control information so that, with respect to those of the control channels corresponding to those of the light emitting elements corresponding to one tier, a phase for the PWM control is set so that phase coincidence is achieved among them.

7. A backlight unit that supplies backlight to a panel on which an image is displayed, comprising:
a plurality of light emitting elements each of which functions as a light source for the backlight; and
a driver device that has a plurality of control channels to each of which one or more of the light emitting elements are connected, and performs PWM control of lighting of the connected light emitting elements,
wherein the driver device sets a non-lighting time period in which a light emitting element is set not to be turned on, independently for each of the control channels.

8. An image display apparatus, comprising:
the backlight unit according to claim 7;
a panel unit that has the panel and uses the backlight to display on the panel, an image based on image data received; and
an image data supply portion that obtains image data and supplies the image data to the backlight unit and to the panel unit,
the image display apparatus realizing display of each frame of the image by displaying fields of a plurality of colors,
wherein each of the light emitting elements emits light of one of the plurality of colors,
the backlight unit receives the image data and generates control information specifying a time period designated for each of the fields of a plurality of colors, and
based on the control information, the driver device sets, in the time period designated for each of the fields, a non-lighting time period with respect to those of the control channels corresponding to the light emitting elements of the colors other than the color of the each of the fields.

9. The backlight unit according to claim 1, wherein
each of the light emitting elements is an LED.

10. A driver device that comprises a plurality of control channels to each of which one or more light emitting elements are connected, and performs PWM control of lighting of the connected light emitting elements, wherein
the driver device sets a frequency or phase for the PWM control independently for each of the control channels.

11. A driver device that comprises a plurality of control channels to each of which one or more light emitting elements are connected, and performs PWM control of lighting of the connected light emitting elements, wherein
the driver device sets a non-lighting time period in which a light emitting element is set not to be turned on, independently for each of the control channels.

12. The driver device according to claim 10, wherein
each of the light emitting elements is an LED.

13. The backlight unit according to claim 2, wherein each of the light emitting elements is an LED.

14. The backlight unit according to claim 7, wherein each of the light emitting elements is an LED.

15. The driver device according to claim 11, wherein each of the light emitting elements is an LED.
